(19) United States
(12) Patent Application Publication
(10) Pub. No.: US 2026/0050768 A1
(43) Pub. Date: Feb. 19, 2026

(54) Split LLM Prompt

(71) Applicant: Palo Alto Networks, Inc., Santa Clara, CA (US)

(72) Inventors: Yohan Hai Guez, Tel Aviv (IL); Guy Holdengreber, Tel Aviv (IL); Lior Perry, Beer Sheva (IL)

(21) Appl. No.: 18/801,902

(22) Filed: Aug. 13, 2024

(51) Int. Cl. G06N 3/0455

(52) U.S. Cl. CPC G06N 3/0455

(57) ABSTRACT

In one embodiment, a device includes a processor configured to receive a request, populate at least one large language model (LLM) prompt template yielding a plurality of populated LLM prompts representing a split LLM prompt of the request such that each of the populated LLM prompts is based on the request, provide the populated LLM prompts as input to the LLM, and receive respective text responses from the LLM based on processing the populated LLM prompts as input, and a memory to store data used by the processor.

The present disclosure relates to computer systems, and in particular, but not exclusively to, large language model (LLM) prompts.

### BACKGROUND

A large language model is a deep learning algorithm that can perform a variety of natural language processing tasks. Large language models generally use transformer models and are trained using huge datasets. Once an LLM has been trained, the LLM may be queried with a prompt to generate a response, which could be an answer to a question, newly generated text, summarized text, or a sentiment analysis report. Among the most common uses for an LLM is via a chatbot where a user interacts in a query-response model.

As previously mentioned, a transformer model is the most common architecture of a large language model. Transformer models work with self-attention mechanisms, which enables models to learn more quickly than traditional models like long short-term memory models. Self-attention is what enables the transformer model to consider different parts of the sequence, or the entire context of a sentence, to generate predictions.

Large language models do have disadvantages. For example, large language models may hallucinate and produce an output that is false, or that does not match the user's intent.

### SUMMARY

There is provided in accordance with an embodiment of the present disclosure, a device, including a processor configured to receive a request, populate at least one large language model (LLM) prompt template yielding a plurality of populated LLM prompts representing a split LLM prompt of the request such that each of the populated LLM prompts is based on the request, provide the populated LLM prompts as input to the LLM, and receive respective text responses from the LLM based on processing the populated LLM prompts as input, and a memory to store data used by the processor.

Further in accordance with an embodiment of the present disclosure the processor is configured to respond to the request based on at least one of the respective text responses.

Still further in accordance with an embodiment of the present disclosure the processor is configured to provide the split prompt to the LLM instead of a single prompt including the request to reduce LLM hallucination.

Additionally in accordance with an embodiment of the present disclosure the processor is configured to provide the split prompt to the LLM instead of a single prompt including the request to improve LLM accuracy.

Moreover, in accordance with an embodiment of the present disclosure the processor is configured to split at least part of the request among the populated LLM prompts such that generation of any one of the populated LLM prompts is not dependent on the respective text responses to other ones of the populated LLM prompts.

Further in accordance with an embodiment of the present disclosure the populated LLM prompts are derived from a same LLM prompt template.

Still further in accordance with an embodiment of the present disclosure a first one of the populated LLM prompts includes a request to identify whether a first topic is relevant to a query, a first text response by the LLM to the first one of the populated LLM prompts indicates a relevance of the first topic, a second one of the populated LLM prompts includes a request to identify whether a second topic is relevant to a query, a second text response by the LLM to the second one of the populated LLM prompts indicates a relevance of the second topic.

Additionally in accordance with an embodiment of the present disclosure the processor is configured to populate a third LLM prompt including a request to answer the query based on relevant found topics.

Moreover, in accordance with an embodiment of the present disclosure the processor is configured to provide the populated LLM prompts to the LLM in an order so that a first text response of the respective text responses received from the LLM in response to a first one of the populated LLM prompts is used in a second one of the populated LLM prompts.

Further in accordance with an embodiment of the present disclosure the populated LLM prompts are derived from different LLM prompt templates.

Still further in accordance with an embodiment of the present disclosure the first one of the populated LLM prompts includes a request to identify a relevant application program interface (API) to perform a given task, the first text response indicates a given API, the processor is configured to generate the second one of the populated LLM prompts to include a reference to the given API and a request to provide parameters of the given API, and a second text response of the respective text responses received from the LLM in response to the second one of the populated LLM prompts includes the API parameters.

Additionally in accordance with an embodiment of the present disclosure the processor is configured to call the given API based on the API parameters.

Moreover, in accordance with an embodiment of the present disclosure the processor is configured to provide a response to a user based on a result of the call of the given API.

There is also provided in accordance with another embodiment of the present disclosure, a method, including receiving a request, populating at least one large language model (LLM) prompt template yielding a plurality of populated LLM prompts representing a split LLM prompt of the request such that each of the populated LLM prompts is based on the request, providing the populated LLM prompts as input to the LLM, and receiving respective text responses from the LLM based on processing the populated LLM prompts as input.

Further in accordance with an embodiment of the present disclosure, the method includes responding to the request based on at least one of the respective text responses.

Still further in accordance with an embodiment of the present disclosure the providing includes providing the split prompt to the LLM instead of a single prompt including the request to reduce LLM hallucination.

Additionally in accordance with an embodiment of the present disclosure the providing includes providing the split prompt to the LLM instead of a single prompt including the request to improve LLM accuracy.

Moreover, in accordance with an embodiment of the present disclosure, the method includes splitting at least part of the request among the populated LLM prompts such that generation of any one of the populated LLM prompts is not dependent on the respective text responses to other ones of the populated LLM prompts.

Further in accordance with an embodiment of the present disclosure the populated LLM prompts are derived from a same LLM prompt template.

Still further in accordance with an embodiment of the present disclosure a first one of the populated LLM prompts includes a request to identify whether a first topic is relevant to a query, a first text response by the LLM to the first one of the populated LLM prompts indicates a relevance of the first topic, a second one of the populated LLM prompts includes a request to identify whether a second topic is relevant to a query, a second text response by the LLM to the second one of the populated LLM prompts indicates a relevance of the second topic.

Additionally in accordance with an embodiment of the present disclosure, the method includes populating a third LLM prompt including a request to answer the query based on relevant found topics.

Moreover, in accordance with an embodiment of the present disclosure the providing includes providing the populated LLM prompts to the LLM in an order so that a first text response of the respective text responses received from the LLM in response to a first one of the populated LLM prompts is used in a second one of the populated LLM prompts.

Further in accordance with an embodiment of the present disclosure the populated LLM prompts are derived from different LLM prompt templates.

Still further in accordance with an embodiment of the present disclosure the first one of the populated LLM prompts includes a request to identify a relevant application program interface (API) to perform a given task, the first text response indicates a given API, the method further includes generating the second one of the populated LLM prompts to include a reference to the given API and a request to provide parameters of the given API, and a second text response of the respective text responses received from the LLM in response to the second one of the populated LLM prompts includes the API parameters.

Additionally in accordance with an embodiment of the present disclosure, the method includes calling the given API based on the API parameters.

Moreover, in accordance with an embodiment of the present disclosure, the method includes providing a response to a user based on a result of the call of the given API.

There is also provided in accordance with still another embodiment of the present disclosure, a software product, including a non-transient computer-readable medium in which program instructions are stored, which instructions, when read by a central processing unit (CPU), cause the CPU to receive a request, populate at least one large language model (LLM) prompt template yielding a plurality of populated LLM prompts representing a split LLM prompt of the request such that each of the populated LLM prompts is based on the request, provide the populated LLM prompts as input to the LLM, and receive respective text responses from the LLM based on processing the populated LLM prompts as input.

### BRIEF DESCRIPTION OF THE DRAWINGS

The present disclosure will be understood from the following detailed description, taken in conjunction with the drawings in which:

FIG. 1 is a partly pictorial, partly block diagram view of an LLM-based computer system constructed and operative in accordance with an embodiment of the present disclosure;

FIG. 2 is a flowchart including steps in a method of processing a horizontal split in the system of FIG. 1;

FIG. 3 is a data flow diagram illustrating processing of a horizontal split in the system of FIG. 1;

FIG. 4 is a data flow diagram illustrating processing of an example query with a horizontal and vertical split in the system of FIG. 1;

FIG. 5 is a flowchart including steps in a method of processing a vertical split in the system of FIG. 1;

FIG. 6 is a data flow diagram illustrating processing of a vertical split in the system of FIG. 1; and

FIG. 7 is a data flow diagram illustrating processing of an example query with a vertical split in the system of FIG. 1.

### DESCRIPTION OF EXAMPLE EMBODIMENTS

### Overview of Example Embodiments

When using a large language model (LLM) in order to build a product, such as a technical support helpdesk, the straightforward approach is to generate an LLM prompt that instructs the LLM with great specificity regarding what to do and how. Due to increased product requirements, the LLM prompts may get large and complex, and request the LLM to perform many separate tasks. At this stage, the LLM may exhibit undesirable behaviors such as a larger tendency for hallucinations, and a tendency to ignore instructions. Additionally, it may be hard to evaluate and debug a prompt as there are many aspects to the prompt and we only see the end result. In some cases, token limits per prompt may be reached.

The above problem may be illustrated based on some simple examples. If a prompt is constructed to find the spouses of the last five presidents of the USA, the LLM may hallucinate and provide a spouse of a president who is not in the list of the last five presidents of the USA. If a prompt is constructed to determine whether each company in a long list of companies was established before 1995 or later, the LLM may hallucinate and make an incorrect determination regarding the data of establishment of one or more of the companies in the list, or ignore one or more companies in the list.

One solution for these types of issues is to perform prompt engineering or working with finetuned/stronger models. In practice, prompt engineering hardly works when the prompt is “saturated”, and any improvements usually come with “collateral damage” which may adversely affect the performance in a different area. Using finetuned/stronger models is not always possible (e.g., if you are already working with the strongest tier model) or requires a large upfront investment to finetune the model when the results are not guaranteed to improve. In addition, many solutions usually have an increased cost attached to them.

Embodiments of the present disclosure address at least some of the above drawbacks by providing a system which uses two or more smaller and logically separate LLM prompts for a request (e.g., query) instead of using a single LLM prompt including the request. The separate LLM prompts may be thought of as a split LLM prompt for the request such that each of the separate LLM prompts is based on the request. The separate LLM prompts may be provided to the LLM at the same time and the text responses of the LLM to each of the LLM prompts may be used to provide a response, e.g., to a user, or to the next stage in a process. Alternatively, or additionally, the separate LLM prompts may be provided to the LLM one-after-the-other, e.g., when one or more of the prompts depend on the text responses provided by the LLM in response to one or more other prompts. For example, a first LLM prompt may be submitted to the LLM, which provides a first text response. The first text response may then be used in a second LLM prompt which is then submitted to the LLM, which provides a second text response. In this case, the second text response, and optionally the first text response, may be used to provide a response, e.g., to a user, or to the next stage in a process.

Prompt splitting is now illustrated by way of some examples.

Returning to the example of finding the spouses of the last five presidents of the USA, a first prompt may be populated to ask the LLM for the names of the last five presidents of the USA. The first prompt is provided to the LLM, which provides a first text response listing the names of the last five presidents of the USA. Then, a second prompt is populated to ask the LLM for the names of the spouses of the people listed in the first text response. The second prompt is provided to the LLM, which provides a second text response listing the names of the spouses of the last five presidents of the USA. The second text response may then be returned to the user. The first LLM prompt and second LLM prompt are typically based on a different LLM templates. The above is an example of a “vertical split” in which the second LLM prompt is populated based on the first text response, and so on. A vertical split may include 2 or more stages one-after-the-other.

Returning to the example of determining whether each company, in a long list of companies, was established before 1995 or later, multiple prompts are populated, typically based on the same LLM template, each prompt being populated to ask the LLM whether the company listed in that prompt was established before 1995 or later. For example, a first prompt may be populated to ask the LLM if ACME Corp was established before 1995 or later, and a second may be populated to ask the LLM if Wayne Corp was established before 1995 or later, and so on. The prompts are provided to the LLM (e.g., in parallel or close together without needing to wait for responses from any of the prompts before submitting any other prompt), and the LLM provides a text response for each of the prompts. The text responses are then used to provide a response to the user to indicate which of the companies were established before 1995 and which of the companies were established later. The above is an example of a “horizontal split” in which any LLM prompt is not dependent on the text response provided by the LLM for any other LLM prompt.

In some cases, a horizontal split or a vertical split may be used, in other cases a combination of a horizontal split and vertical split may be used, depending on the nature of the request and the application. A combination of a horizontal split and vertical split is described in disclosed embodiments.

The following is an example of a horizontal split and vertical split combination. Instead of using a single prompt to ask the LLM to find an answer to a query based on a number of potentially relevant topics (e.g., documents), a split prompt may be generated. Suppose there are six possible topics, then six prompts may be populated based on the same LLM prompt template to determine if each of the topics is relevant to the query. For example, a first prompt may be populated to identify whether topic 1 is relevant to the query, a second prompt may be populated to identify whether topic 2 is relevant to the query, and so on. The prompts are provided to the LLM, and the LLM provides respective text responses to each of the prompts indicating for each prompt whether the respective topic is relevant, or not. Let's suppose that topics 2 and 4 are deemed to be relevant by the LLM, then an additional LLM prompt may be populated from a different LLM prompt template to request an answer to the query based on the found relevant topics, i.e. topics 2 and 4. The additional LLM prompt is provided to the LLM, and the LLM provides a text response indicating an answer to the query based on the relevant topics (e.g., based on topics 2 and 4). The answer may then be used to format a response, e.g., to a user.

The following is an additional example of a vertical split for use with a technical support helpdesk. Suppose that a database stores computer system data including logs, and the system includes relevant APIs to call in order to access data. A user may write a query such as “Give me incident number 61”. Instead of using a single prompt to ask the LLM to provide the API and API parameters to retrieve incident number 61, a first LLM prompt is populated from an LLM prompt template to identify a relevant API to find incidents. The first LLM prompt is provided to the LLM, which provides a text response including the name of the relevant API, e.g., get_incident. A second LLM prompt is populated from a different LLM prompt templated based on the text response. The second LLM prompt may include a request to the LLM to provide parameters for the relevant API, e.g., get_incident, for incident 61. The second prompt is provided to the LLM, which provides a text response including the relevant API parameters of get_incident for incident 61. The system calls get_incident using the found API parameters and receives the details of incident number 61. The details of incident number 61 are then provided to the user.

Although splitting the LLM prompt may add overhead (such as cost and latency) to the system, with the correct design it may be possible to parallelize many of the steps leading to a marginal latency hit but greatly improved performance including reduced LLM hallucination and/or improved LLM accuracy. In addition, separate prompts may allow debugging of the prompt in a more efficient manner as each step may be evaluated and modified separately.

### System Description

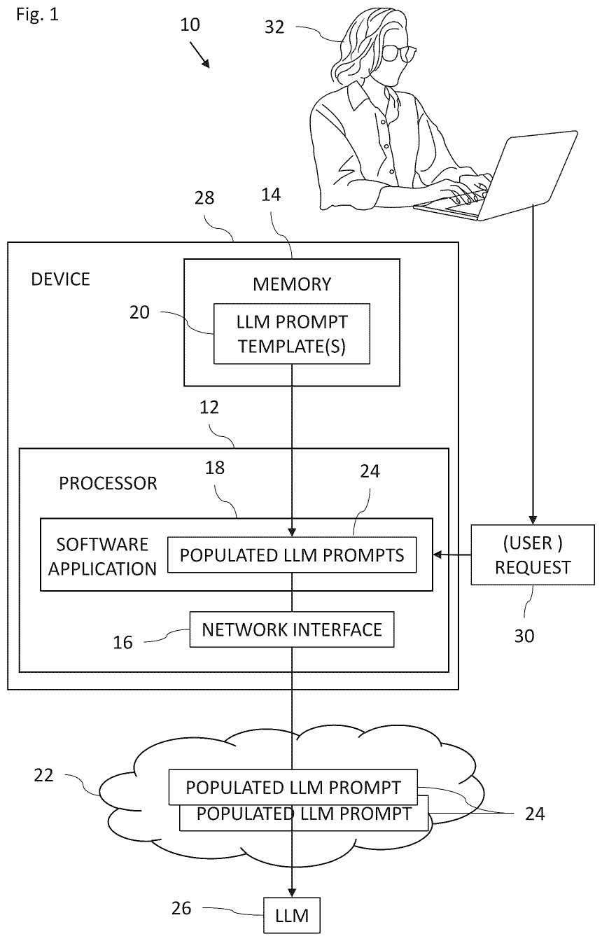

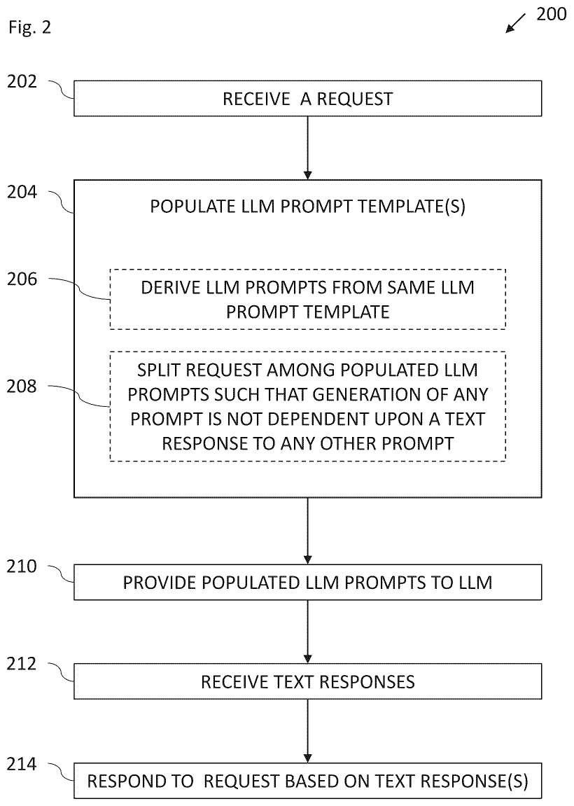

Reference is now made to FIGS. 1 and 2. FIG. 1 is a partly pictorial, partly block diagram view of an LLM-based computer system 10 constructed and operative in accordance with an embodiment of the present disclosure. FIG. 2 is a flowchart 200 including steps in a method of processing a horizontal split in the system 10 of FIG. 1.

The LLM-based computer system 10 includes a device 28 (e.g., a processing device) including a processor 12, a memory 14, and a network interface 16. The processor 12 is configured to execute a software application 18, e.g., a technical support helpdesk application. The memory 14 is configured to store data used by the processor 12 including one or more LLM prompt templates 20. The network interface 16 is configured to share data with one or more remote devices over a network 22, for example, to send populated LLM prompts 24 to an LLM 26 running on a remote server. In some embodiments, the LLM 26 may be local, i.e., running on device 28. The software application 18 running on processor 12 is configured to receive a request 30 (e.g., user request) from a user 32 or any suitable entity, such as another device (block 202). The request 30 may take the form of a query. The software application 18 running on processor 12 is configured to retrieve LLM prompt template(s) 20 from memory 14 (block 204) and populate LLM prompt template(s) 20 yielding populated LLM prompts 24 representing a split LLM prompt of the request 30 such that each of the populated LLM prompts 24 is based on the request 30 (block 204). The software application 18 running on the processor 12 is configured to provide the split prompt to the LLM 26, instead of a single prompt including the request, in order to reduce LLM hallucination and/or to improve LLM accuracy.

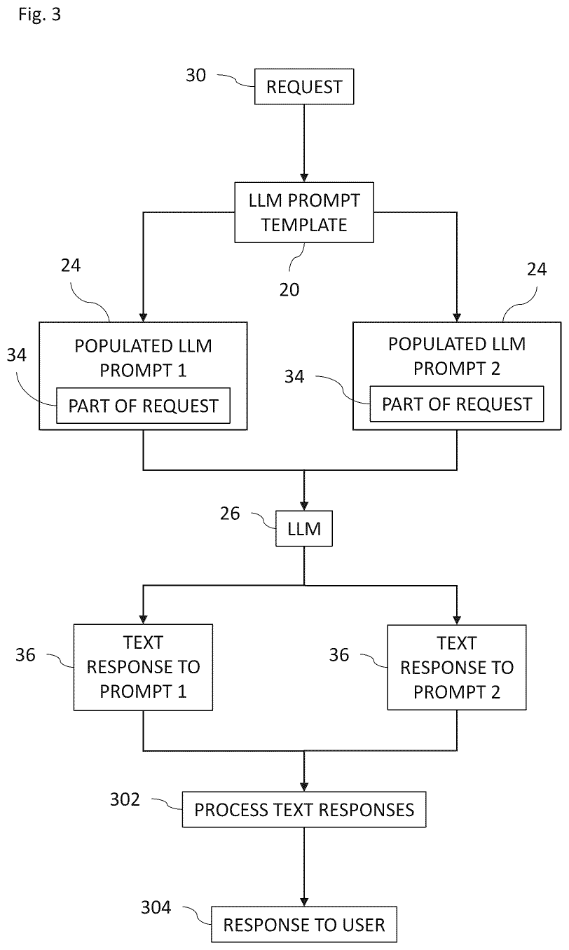

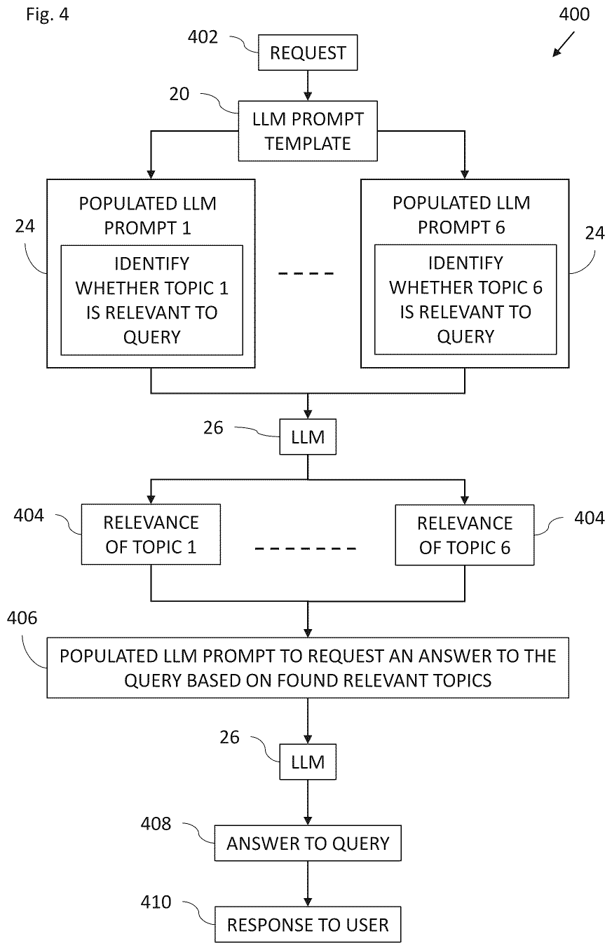

When a horizontal split is used, described in more detail with reference to FIGS. 3 and 4, the software application 18 running on the processor 12 is configured to derive (i.e., populate) the populated LLM prompts 24 from the same LLM prompt template 20 (block 206). The software application 18 is configured to select at least part of the request 30 to populate the LLM prompt template 20 multiple times such that different parts of the request 30 are disposed in different populated LLM prompts 24 derived from the same LLM prompt template 20. For example, part A of the request 30 may be disposed in populated LLM prompt 1, and part B of the request 30 may be disposed in populated LLM prompt 2, and so on. The software application 18 is configured to populate the LLM prompt template 20 as many times as necessary (e.g., 2 or more times) in order to divide the relevant parts of the request 30 among the populated LLM prompts 24. In a horizontal split, the data included in any of the populated LLM prompts 24 are generally independent of any of the text responses to any one or more of the other populated LLM prompts 24. Therefore, the software application 18 running on processor 12 is configured to split at least part of the request 30 among the populated LLM prompts 24 such that generation of any one of the populated LLM prompts is not dependent on any one of the respective text responses to other ones of the populated LLM prompts (block 208).

The software application 18 running on the processor 12 is configured to provide the populated LLM prompts 24 as input to the LLM 26 (block 210). As the populated LLM prompts 24 are not dependent on any of the text responses of other populated LLM prompts 24, the populated LLM prompts 24 may be provided to the LLM 26 for processing at the same time or at substantially the same time.

The LLM 26 is configured to process the populated LLM prompts 24, and provide respective text responses to the software application 18. The software application 18 running on processor 12 is configured to receive the respective text responses from the LLM 26 based on processing the populated LLM prompts 26 as input (block 212). For example, the software application 18 is configured to receive a first text response to a first LLM prompt, a second text response to a second LLM prompt, and so on. The software application 18 running on processor 12 is configured to respond to the request 30 based on at least one of the respective text responses (block 214).

In practice, some or all of the functions of processor 12 may be combined in a single physical component or, alternatively, implemented using multiple physical components. These physical components may comprise hard-wired or programmable devices, or a combination of the two. In some embodiments, at least some of the functions of the processor 12 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

Reference is now made to FIG. 3, which is a data flow diagram 300 illustrating processing of a horizontal split in the system 10 of FIG. 1. The request 30 is received and the LLM prompt template 20 is retrieved and two populated LLM prompts 24 are populated from the same LLM prompt template 20 by adding parts 34 from the request 30 to each of the LLM prompts 24 (e.g., populated LLM prompt 1 and populated LLM prompt 2). Two populated LLM prompts 24 are shown by way of example. Any suitable number of populated LLM prompts 24 may be populated. The populated LLM prompts 24 are provided to LLM 26 which processes each of the populated LLM prompts 24 and provides respective text responses 36 (e.g., a text response to prompt 1 and a text response to prompt 2). The software application 18 is configured to process (block 302) the text responses 36 to yield a response, which is provided to the user or other entity (block 304).

Reference is now made to FIG. 4, which is a data flow diagram 400 illustrating processing of an example query with a horizontal and vertical split in the system 10 of FIG. 1. Instead of using a single prompt to ask the LLM to find an answer to a query based on a number of potentially relevant topics (e.g., documents), a split prompt may be generated. Suppose there are six possible topics, then six prompts may be populated based on the same LLM prompt template to determine if each of the topics is relevant to the query. For example, a first prompt may be populated to identify whether topic 1 is relevant to the query, a second prompt may be populated to identify whether topic 2 is relevant to the query, and so on. The example is now described in more detail.

The software application 18 is configured to receive a request 402 (e.g., query) from a user or entity. In the example of FIG. 4, the request 402 lists 6 possible topics (e.g., documents). The same LLM prompt template 20 is used to generate 6 different populated LLM prompts 24 by populating the LLM prompt template 20 six times, once for each of the topics. For example, populated LLM prompt 1 includes a request to identify whether topic 1 is relevant to the query, populated LLM prompt 2 (not shown) includes a request to identify whether topic 2 is relevant to the query, and so on, until all 6 populated LLM prompts 24 are populated with the respective topics.

The populated LLM prompts 24 are provided to LLM 26, which processes the populated LLM prompts 24 and provides 6 text responses 404 corresponding to the 6 populated LLM prompts 24 and indicates a relevance of each topic (e.g., a relevance of topic 1, a relevance of topic 2, and so on). In other words, a text response by the LLM 26 to populated LLM prompt 1 indicates a relevance of topic 1, a text response by the LLM 26 to populated LLM prompt 2 indicates a relevance of topic 2, and so on.

Let's suppose that topics 2 and 4 are deemed by LLM 26 to be relevant. The software application 18 running on processor 12 is configured to populate (block 406) an additional LLM prompt from a different LLM prompt template. The additional LLM prompt includes a request to answer the query based on the relevant found topics, i.e., topics 2 and 4. The additional LLM prompt is provided to the LLM 26, and the LLM provides a text response indicating an answer to the query (block 408). The answer may then be used to format a response, e.g., to a user or other entity (block 410).

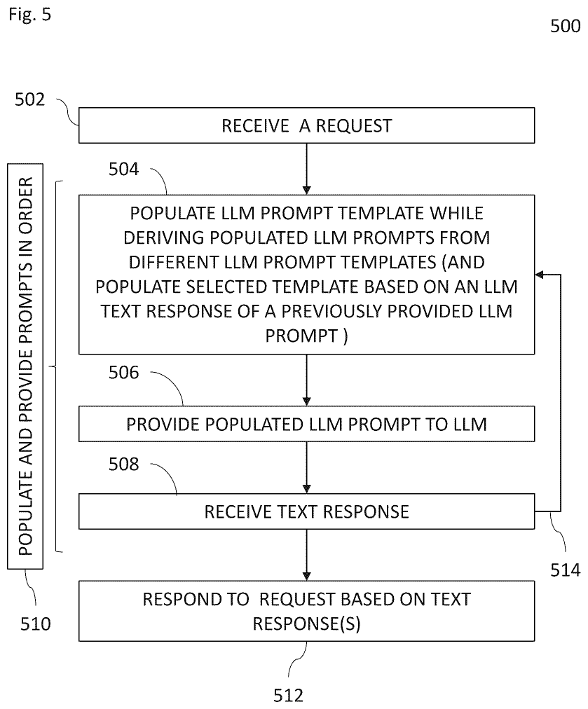

Reference is now made to FIG. 5, which is a flowchart 500 including steps in a method of processing a vertical split in the system 10 of FIG. 1. The software application 18 running on processor 12 is configured to receive request 30 (block 502), populate an LLM prompt 24 from a LLM prompt template 20 based on at least part of request 30 (block 504), provide the populated LLM prompt 24 to LLM 26 (block 506), and receive a text response from the LLM 26 based on the LLM 26 processing the populated LLM prompt 24 (block 508).

The steps of blocks 504-508 are repeated (arrow 514) with the following changes. The software application 18 running on processor 12 is configured to populate an additional populated LLM prompt 24 from a different LLM prompt template 20 and based on the text response from the LLM 26 to one or more previously processed LLM prompts, and based on at least (a different) part of request 30. The steps of blocks 504-508 may be repeated an addition one or more times, as needed, yielding one or more respective text responses to the LLM prompts provided to LLM 26.

In general, the software application 18 running on processor 12 is configured to provide the populated LLM prompts 24 to the LLM 26 in an order (block 510) so that a first text response received from the LLM in response to a first populated LLM prompts is used in a second populated LLM prompt, and so on. Additionally, the populated LLM prompts are generally derived from different LLM prompt templates 20. A third populated LLM prompt (if used) may be derived from the text response to the first populated LLM prompt and/or the text response to the second populated LLM prompt. In general, a populated LLM prompt may be populated based on at least part of request 30 and one or more text responses to populated LLM prompts previously provided to LLM 26.

The software application 18 is configured to prepare a response to the request 30 based on one or more of the text responses received in the step of block 508 (block 512).

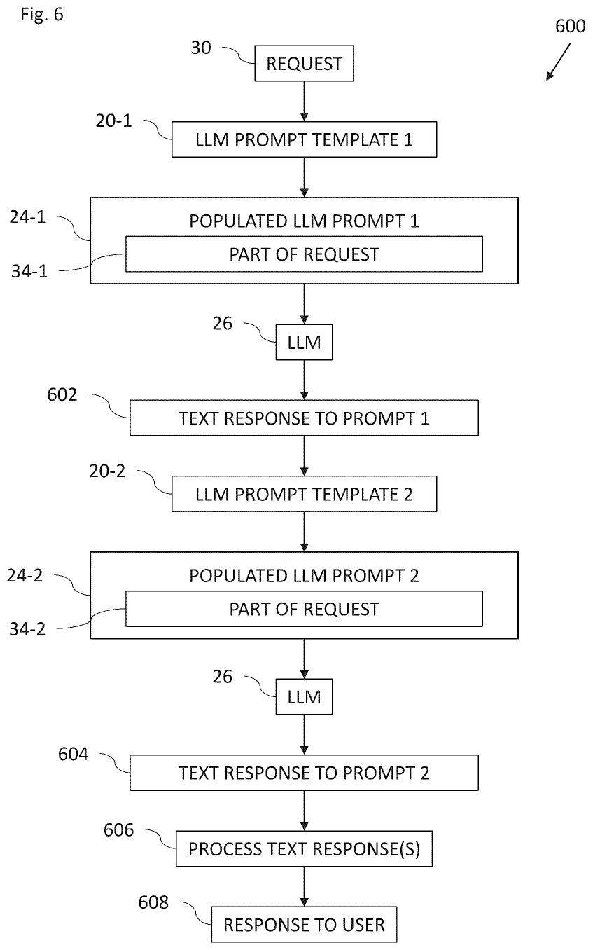

Reference is now made to FIG. 6, which is a data flow diagram 600 illustrating processing of a vertical split in the system 10 of FIG. 1. The software application 18 is configured to receive request 30 and populate a first LLM prompt template 20-1 based on at least part 34-1 of request 30 yielding a first populated LLM prompt 24-1. The software application 18 is configured to provide populated LLM prompt 24-1 to LLM 26, which processes the populated LLM prompt 24-1 and provides a text response (block 602) to populated LLM prompt 24-1. The software application 18 is configured to receive text response (block 602) and populate a second LLM prompt template 20-2 based on at least part 34-2 of request 30 and the received text response yielding a second populated LLM prompt 24-2. The software application 18 is configured to provide populated LLM prompt 24-2 to LLM 26, which processes the populated LLM prompt 24-2 and provides a text response (block 604) to populated LLM prompt 24-2. The software application 18 is configured to receive the text response to populated LLM prompt 24-2 and process one or more of the text responses provided by the LLM 26 (block 606) to yield a request (or query) response and provide the request response to the user or other entity (block 608).

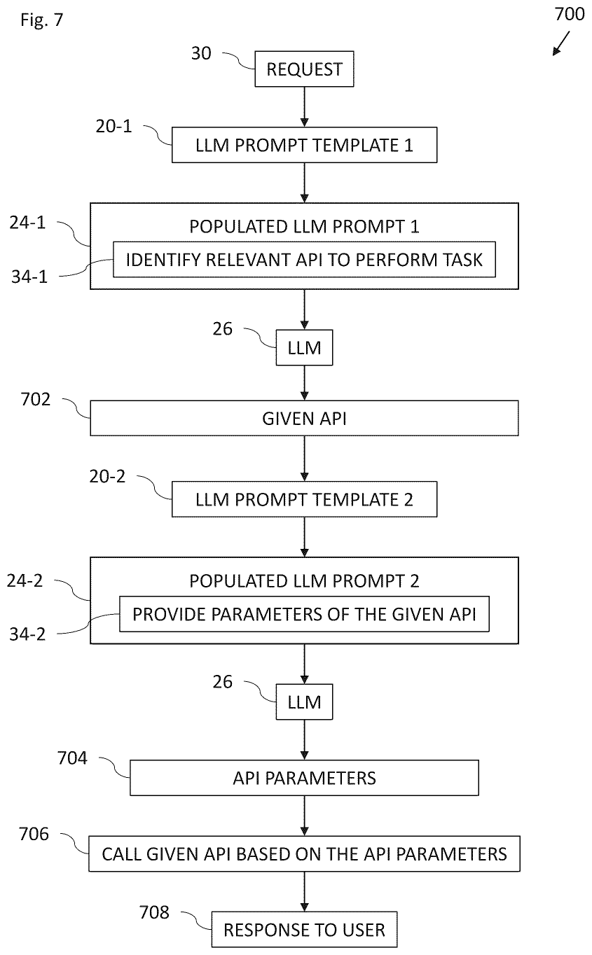

Reference is now made to FIG. 7, which is a data flow diagram 700 illustrating processing of an example query with a vertical split in the system 10 of FIG. 1. Suppose that a database stores computer system data including logs, and the system 10 includes relevant APIs to call in order to access data. A user may write a query such as “Give me incident number 61”. Instead of using a single prompt to ask the LLM to provide the API and API parameters to retrieve incident number 61, the software application 18 uses a split prompt using a vertical split, as described in more detail below.

The software application 18 is configured to: receive request 30 (e.g., including the query “Give me incident number 61”; and populate a first LLM prompt template 20-1 based on at least part 34-1 of request 30 (i.e., to find an incident) yielding a first populated LLM prompt 24-1. The populated LLM prompt 24-1 may include a request to identify a relevant application program interface (API) to perform a given task, i.e., to find an incident. The software application 18 is configured to provide populated LLM prompt 24-1 to LLM 26, which processes the populated LLM prompt 24-1 and provides a text response (block 702) to populated LLM prompt 24-1. The software application 18 is configured to receive the text response (block 702). The text response (block 702) indicates a given API and may include the name of the relevant API, e.g., get_incident.

The software application 18 is configured to populate a second LLM prompt template 20-2 (which is different from LLM prompt template 20-1) based on at least part 34-2 (e.g., incident 61) of request 30 and the text response (block 702) yielding a second populated LLM prompt 24-2. The software application 18 is configured to generate populated LLM prompt 20-2 to include a reference to the given API (e.g., get_incident) and a request to provide parameters of the given API for incident 61. The software application 18 is configured to provide populated LLM prompt 24-2 to LLM 26, which processes the populated LLM prompt 24-2 and provides a text response (block 704) to populated LLM prompt 24-2. Text response (block 704) includes the API parameters for incident 61.

The software application 18 is configured to process one or more of the text responses provided by the LLM 26 and call the given API (e.g., get_incident) based on the API parameters provided by LLM 26 (block 706). The software application 18 is configured to receive details of incident number 61 based on the API call. The software application 18 running on processor 12 is configured to provide a response (e.g., details of incident 61) to a user or other entity based on a result of the call of the given API (e.g., get_incident) (block 708).

Various features of the disclosure which are, for clarity, described in the contexts of separate embodiments may also be provided in combination in a single embodiment. Conversely, various features of the disclosure which are, for brevity, described in the context of a single embodiment may also be provided separately or in any suitable sub-combination.

The embodiments described above are cited by way of example, and the present disclosure is not limited by what has been particularly shown and described hereinabove. Rather the scope of the disclosure includes both combinations and sub-combinations of the various features described hereinabove, as well as variations and modifications thereof which would occur to persons skilled in the art upon reading the foregoing description and which are not disclosed in the prior art.

What is claimed is:

1. A device, comprising:
a processor configured to:
receive a request;
populate at least one large language model (LLM) prompt template yielding a plurality of populated LLM prompts representing a split LLM prompt of the request such that each of the populated LLM prompts is based on the request;
provide the populated LLM prompts as input to the LLM; and
receive respective text responses from the LLM based on processing the populated LLM prompts as input; and
a memory to store data used by the processor.

2. The device according to claim 1, wherein the processor is configured to respond to the request based on at least one of the respective text responses.

3. The device according to claim 1, wherein the processor is configured to provide the split prompt to the LLM instead of a single prompt including the request to reduce LLM hallucination.

4. The device according to claim 1, wherein the processor is configured to provide the split prompt to the LLM instead of a single prompt including the request to improve LLM accuracy.

5. The device according to claim 1, wherein the processor is configured to split at least part of the request among the populated LLM prompts such that generation of any one of the populated LLM prompts is not dependent on the respective text responses to other ones of the populated LLM prompts.

6. The device according to claim 5, wherein the populated LLM prompts are derived from a same LLM prompt template.

7. The device according to claim 5, wherein:
a first one of the populated LLM prompts includes a request to identify whether a first topic is relevant to a query;
a first text response by the LLM to the first one of the populated LLM prompts indicates a relevance of the first topic;
a second one of the populated LLM prompts includes a request to identify whether a second topic is relevant to a query;
a second text response by the LLM to the second one of the populated LLM prompts indicates a relevance of the second topic.

8. The device according to claim 7, wherein the processor is configured to populate a third LLM prompt including a request to answer the query based on relevant found topics.

9. The device according to claim 1, wherein the processor is configured to provide the populated LLM prompts to the LLM in an order so that a first text response of the respective text responses received from the LLM in response to a first one of the populated LLM prompts is used in a second one of the populated LLM prompts.

10. The device according to claim 9, wherein the populated LLM prompts are derived from different LLM prompt templates.

11. The device according to claim 9, wherein:
the first one of the populated LLM prompts includes a request to identify a relevant application program interface (API) to perform a given task;
the first text response indicates a given API;
the processor is configured to generate the second one of the populated LLM prompts to include a reference to the given API and a request to provide parameters of the given API; and
a second text response of the respective text responses received from the LLM in response to the second one of the populated LLM prompts includes the API parameters.

12. The device according to claim 11, wherein the processor is configured to call the given API based on the API parameters.

13. The device according to claim 12, wherein the processor is configured to provide a response to a user based on a result of the call of the given API.

14. A method, comprising:
receiving a request;
populating at least one large language model (LLM) prompt template yielding a plurality of populated LLM prompts representing a split LLM prompt of the request such that each of the populated LLM prompts is based on the request;
providing the populated LLM prompts as input to the LLM; and
receiving respective text responses from the LLM based on processing the populated LLM prompts as input.

15. The method according to claim 14, further comprising responding to the request based on at least one of the respective text responses.

16. The method according to claim 14, wherein the providing includes providing the split prompt to the LLM instead of a single prompt including the request to reduce LLM hallucination.

17. The method according to claim 14, wherein the providing includes providing the split prompt to the LLM instead of a single prompt including the request to improve LLM accuracy.

18. The method according to claim 14, further comprising splitting at least part of the request among the populated LLM prompts such that generation of any one of the populated LLM prompts is not dependent on the respective text responses to other ones of the populated LLM prompts.

19. The method according to claim 18, wherein the populated LLM prompts are derived from a same LLM prompt template.

20. The method according to claim 18, wherein:
a first one of the populated LLM prompts includes a request to identify whether a first topic is relevant to a query;
a first text response by the LLM to the first one of the populated LLM prompts indicates a relevance of the first topic;
a second one of the populated LLM prompts includes a request to identify whether a second topic is relevant to a query;
a second text response by the LLM to the second one of the populated LLM prompts indicates a relevance of the second topic.

21. The method according to claim 20, further comprising populating a third LLM prompt including a request to answer the query based on relevant found topics.

22. The method according to claim 14, wherein the providing includes providing the populated LLM prompts to the LLM in an order so that a first text response of the respective text responses received from the LLM in response to a first one of the populated LLM prompts is used in a second one of the populated LLM prompts.

23. The method according to claim 22, wherein the populated LLM prompts are derived from different LLM prompt templates.

24. The method according to claim 22, wherein:
the first one of the populated LLM prompts includes a request to identify a relevant application program interface (API) to perform a given task;
the first text response indicates a given API;
the method further comprises generating the second one of the populated LLM prompts to include a reference to the given API and a request to provide parameters of the given API; and
a second text response of the respective text responses received from the LLM in response to the second one of the populated LLM prompts includes the API parameters.

25. The method according to claim 24, further comprising calling the given API based on the API parameters.

26. The method according to claim 25, further comprising providing a response to a user based on a result of the call of the given API.

27. A software product, comprising a non-transient computer-readable medium in which program instructions are stored, which instructions, when read by a central processing unit (CPU), cause the CPU to:
receive a request;
populate at least one large language model (LLM) prompt template yielding a plurality of populated LLM prompts representing a split LLM prompt of the request such that each of the populated LLM prompts is based on the request;
provide the populated LLM prompts as input to the LLM; and
receive respective text responses from the LLM based on processing the populated LLM prompts as input.
